(19) United States
(12) Patent Application Publication
(10) Pub. No.: US 2013/0255616 A1
(43) Pub. Date: Oct. 3, 2013

(54) Air-Guiding Device for Vehicles and Method for Making the Same

(71) Applicant: Micro Sutures & Golden-Tech Co., Ltd., (US)

(72) Inventor: Duan Yao, Homei (TW)

(73) Assignee: Micro Sutures & Golden-Tech Co., Ltd., Homei (TW)

(21) Appl. No.: 13/744,350

(22) Filed: Jan. 17, 2013

(30) Foreign Application Priority Data
Mar. 27, 2012 (TW) 101110468

(51) Int. Cl. F02M 35/104; B21D 51/16

(52) U.S. Cl. CPC F02M 35/104; B21D 51/16
USPC 123/184.21; 72/324; 72/339; 72/46; 72/203

(57) ABSTRACT

An air-guiding device is used in an intake manifold arranged between an internal combustor and an air-filtering device. The air-guiding device is a tubular element made of a flexible metal sheet and includes a positioning section and an air-guiding section. The positioning section is fit in the intake manifold. The air-guiding section includes helical blades that converge as they extend from the positioning section.

### BACKGROUND OF INVENTION

1. Field of the Invention

The present invention relates to an air-guiding device for vehicles and, more particularly, to an easily made, inexpensive, environmentally friendly and turbulence-efficient air-guiding device for vehicles.

2. Related Prior Art

To efficiently mix air with fuel to improve combustion to reduce deposit of carbon in internal combustors of vehicles, there have been various air-guiding devices. A first type of air-guiding devices includes a tube, an axle inserted in the tube, and helical blades attached to or formed on the axle. The tube is placed in an intake manifold arranged between an internal combustor and an air-filtering device. As the axle rotates, the helical blades produce turbulences in the air that travels into the internal combustor from the air-filtering device through the intake manifold. The air mixes with the fuel in the internal combustor faster with the turbulences than without. The use of this type of air-guiding devices is not without problems. At first, the axle hinders the flow of the air and the operation of the turbulences. Secondly, the direction of the helical blades cannot be adjusted to achieve the optimum effect in various applications. Thirdly, the diameter of the tube cannot be adjusted to fit various applications. Fourthly, it is expensive because of the number and materials of the elements used therein.

A second type of air-guiding devices includes a tube and helical blades formed on or attached to an internal face of the tube. The helical blades produce turbulences in the air on its way into the internal combustor from the air-filtering device. The use of the second type of air-guiding devices is not without problems. At first, the direction of the helical blades cannot be adjusted to achieve the optimum effect in various applications. Secondly, the diameter of the tube cannot be adjusted to fit various applications. Fourthly, it is expensive due to the number and materials of the elements used therein. The present invention is therefore intended to obviate or at least alleviate the problems encountered in prior art.

### SUMMARY OF INVENTION

It is an objective of the present invention to provide an easily made, inexpensive, environmentally friendly and efficient air-guiding device for use in an intake manifold arranged between an internal combustor and an air-filtering device.

To achieve the fore going objective, the air-guiding device is a tubular element made of a flexible metal sheet and includes a positioning section and an air-guiding section. The positioning section is fit in the intake manifold. The air-guiding section includes helical blades that converge as they extend from an end of the positioning section.

It is another objective of the present invention to provide a method for making an easily made, inexpensive, environmentally friendly and efficient air-guiding device for use in an intake manifold arranged between an internal combustor and an air-filtering device.

To achieve the foregoing objective, the method includes the steps of providing a flexible metal tube, forming plain blades by cutting the flexible metal tube, and forming helical blades by bending the plain blades.

In an alternative aspect, the method includes the steps of providing a flexible metal sheet, providing a positioning section and an air-guiding section by cutting the flexible metal sheet, forming plain blades by cutting slits in the air-guiding section, rolling the positioning section, and bending the plain lades into helical blades.

Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is a perspective view of an air-guiding device according to the first embodiment of the present invention;

FIG. 2 is a cross-sectional view of the air-guiding device shown in FIG. 1;

FIG. 3 is front view of the air-guiding device shown in FIG. 1;

FIG. 4 is a top view of a vehicle equipped with the air-guiding device shown in FIG. 1;

FIG. 5 is side view of the air-guiding device shown in FIG. 1;

FIG. 6 is an exploded view of an air-guiding device according to the second embodiment of the present invention;

FIG. 7 is a cross-sectional view of the air-guiding device shown in FIG. 6;

FIG. 8 is another cross-sectional view of the air-guiding device shown in FIG. 6;

FIG. 9 is a top view of a vehicle equipped with the air-guiding device shown in FIG. 6;

FIG. 10 is a flow chart of a method for making the air-guiding device shown in FIG. 1 or 6;

FIG. 11 is a flow chart of a method for making an air-guiding device according to a third embodiment of the present invention;

FIG. 12 shows the process of turning a flexible metal sheet to a semi-product of the air-guiding device according to the third embodiment of the present invention;

FIG. 13 is a perspective view of the air-guiding device according to the third embodiment of the present invention; and

FIG. 14 is a cross-sectional view of an intake manifold that contains an air-guiding device according to the fourth embodiment of the present invention.

### DETAILED DESCRIPTION OF EMBODIMENTS

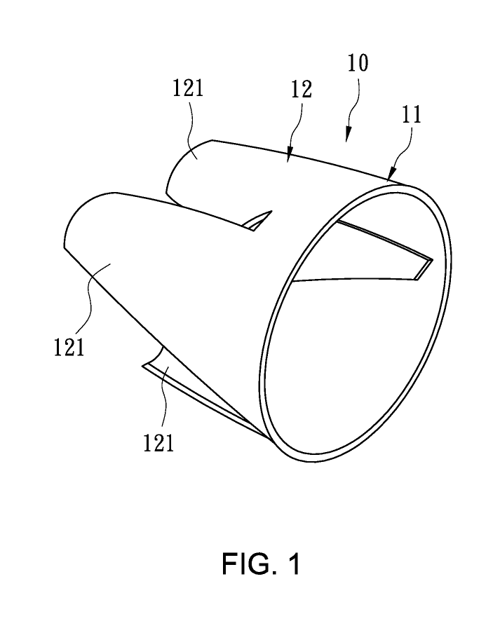

Referring to FIGS. 1 to 5, there is shown an air-guiding device 10 in accordance with a first embodiment of the present invention. As shown in FIGS. 1 and 3, the air-guiding device 10 is made of a flexible metal tube. The flexible metal tube can be formed by molding. Alternatively, a flexible metal sheet can be rolled into the flexible metal tube. The air-guiding device 10 includes a positioning section 11 and an air-guiding section 12. The air-guiding section 12 includes three evenly located helical blades 121 for example. The helical blades 121 converge as they extend from the positioning section 11.

That is, an internal diameter of the air-guiding section 12 gets smaller as it extends from the positioning section 11. As shown in FIG. 3, the tips of the helical blades 121 are closer to the axis of the positioning device 10 than the roots of the same.

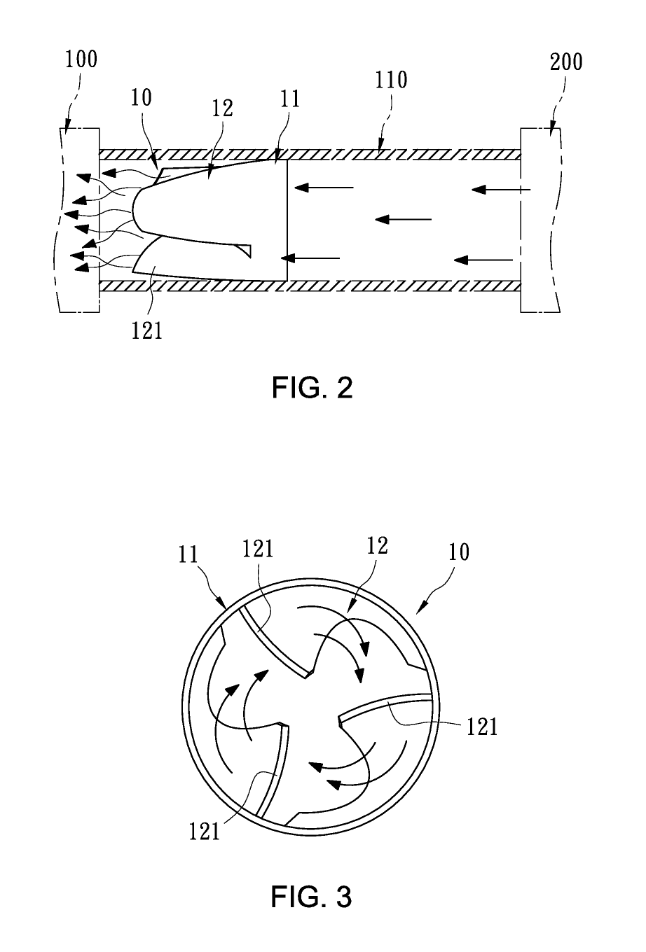

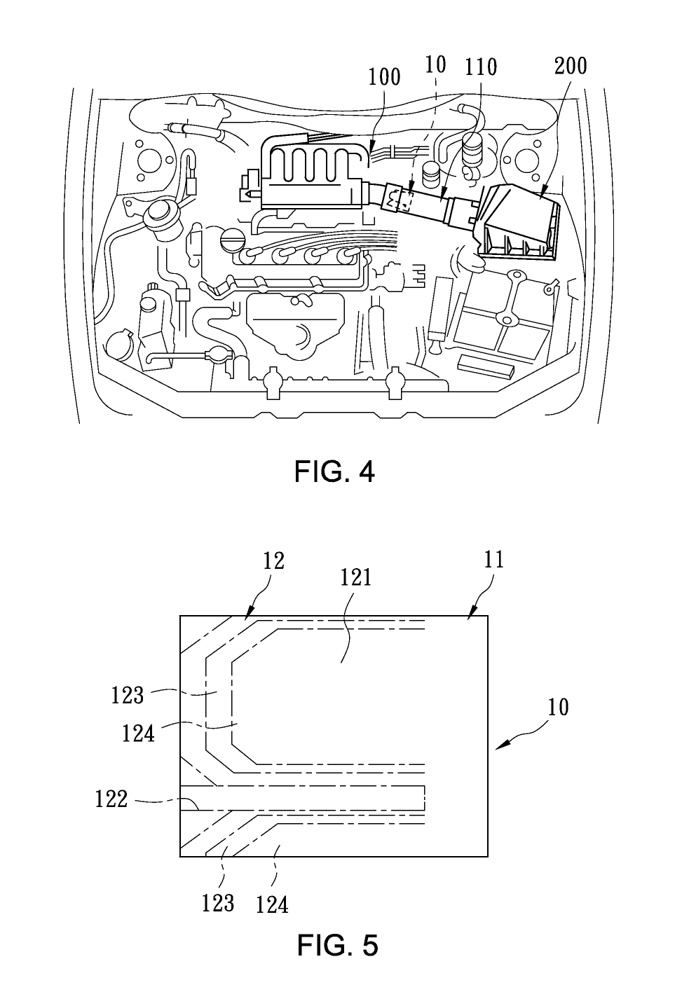

Referring to FIGS. 2 and 4, the air-guiding device 10 is placed in an intake manifold 110 arranged between an internal combustor 100 and an air-filtering device 200. The air-guiding device 10 is fit in the intake manifold 110, i.e., an external face of the positioning section 11 of the air-guiding device 10 is tight against an internal face of the intake manifold 110. Thus, the air-guiding device 10 is kept in the intake manifold 110. Air is sent into the internal combustor 100 from the air-filtering device 200 via the intake manifold 110.

The air travels in a steady flow before the air reaches the air-guiding section 12 of the air-guiding device 10. The steady flow of the air is turned into turbulences by the helical blades 121 as the air flows through the air-guiding section 12 of the air-guiding device 10. The speed of the air gets higher as the air flows toward the internal combustor 100 from the air-filtering device 200 because the helical blades 121 converge in the same direction. The turbulences of the air enable the air to produce fast vortices that quickly mix the air with fuel in the internal combustor 100. Thus, the air/fuel ratio is increased and so is the efficiency of the combustion of the fuel in the internal combustor 100. Accordingly, carbon deposit is reduced in the internal combustor 100.

Referring to FIG. 5, a first group of lines 122, a second group of lines 123 and a third group of lines 124 are printed on a flexible metal tube that is used to make the air-guiding device 10. The flexible metal tube can be cut along the first group of lines 122, the second group of lines 123 or the third group of lines 124. The portions that are defined by cutting along each group of lines 122, 123 or 124 can be bent to form the helical blades 121. The helical blades 121 are larger as they are defined by cutting along the first group of lines 122 than the second group of lines 123. The blades 121 are larger as they are defined by cutting along the second group of lines 123 than the third group of lines 124.

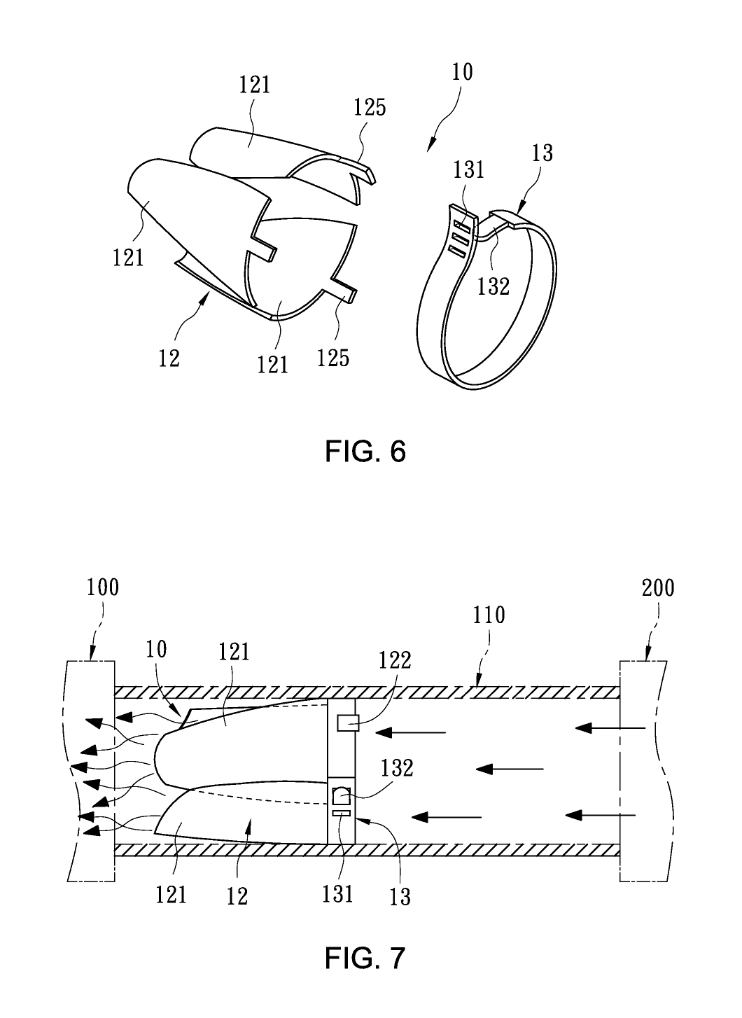

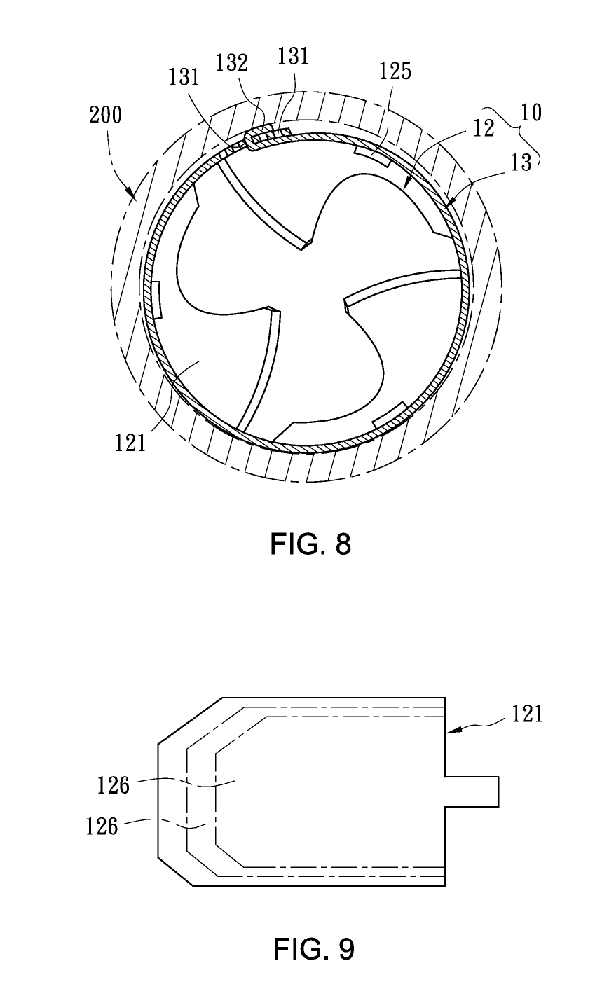

Referring to FIGS. 6 through 9, there is shown an air-guiding device according to a second embodiment of the present invention. The second embodiment is like the first embodiment except that the air-guiding section 12 and the positioning section 13 are made independently and then joined together.

The air-guiding section 12 includes three helical blades 121 that are made independently. Each of the helical blades 121 is made of a flexible metal sheet. Each of the flexible sheets is printed with three lines 126 for example. Each of the flexible sheets is cut along a selected one of the lines 126 to form a plain blade of a desired one of three sizes. The flexible sheets can easily be cut with a pair of scissors. Each of the plain blades is bent to form a helical blade 121. Each of the helical blades 121 includes a tab 125 extending from an end.

The positioning section 13 is made of a flexible metal band. The positioning section 13 includes three slots 131 defined therein near an end and an insert 132 extending from another end. The positioning section 13 may include any other proper number of slots 131 in another embodiment. The insert 132 is inserted in one of the slots 131 to turn the positioning section 13 into a loop of one of three external diameters.

In assembly, the tabs 125 are connected to the positioning section 13 by adhesion or any other proper means. The insert 132 is inserted in a slot 131. Then, the insert 132 is bent and turned into a hook for hooking the end of the positioning section 13 near which the slots 131 are defined.

In use, the air-guiding device 10 is fit in the intake manifold 110, which is arranged between the air-filtering device 100 and the internal combustor 200. Based on the internal diameter of the intake manifold 110, the air-guiding device 10 is made of a selected one of three sizes, i.e., the insert 132 is inserted through a corresponding one of the slots 131 and each of the helical blades 121 is made of a corresponding one of the sizes.

Although not shown, the positioning section 13 may include additional slots defined therein. In this case, the tabs 125 are inserted through the additional slots and bent and turned into hooks for hooking the positioning section 13.

The cost of the flexible metal sheets for the helical blades 121 is low, and the cost of cutting the helical blades 121 is low. The cost of the flexible metal band for the positioning section 13 is low, and the cost of cutting the slots 131 in the flexible metal band is low. Hence, the air-guiding device is inexpensive.

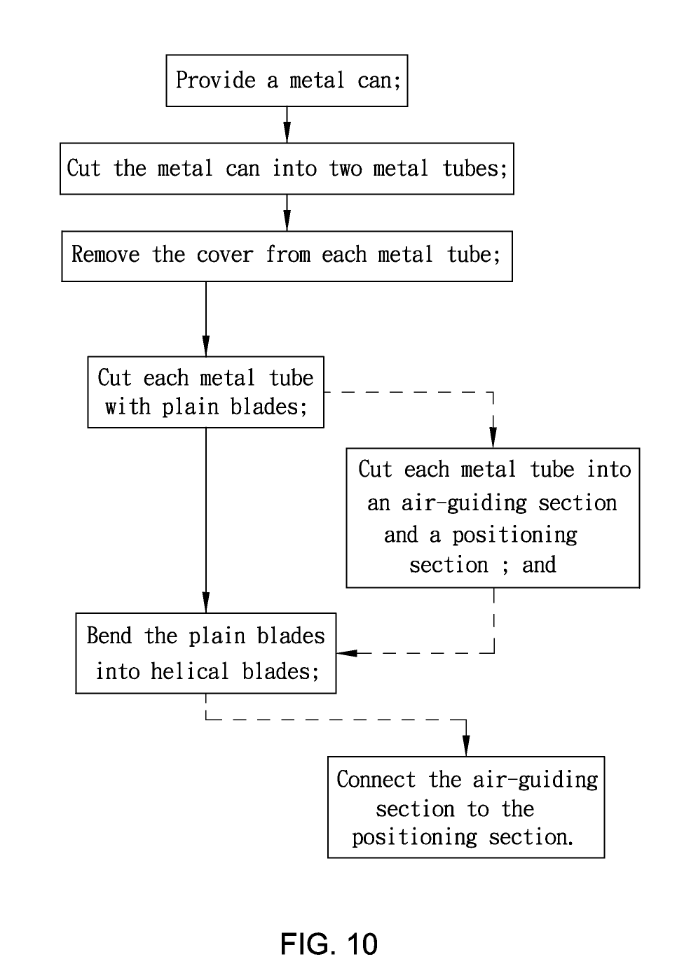

Referring to FIG. 10, there is shown a method for making the air-guiding device 10 shown in FIGS. 1 through 5. At first, there is provided a recycled metal can. The recycled metal can is an aluminum can or an iron can for example.

Then, the metal can is cut into halves.

Then, a cover is cut from each half of the metal can, thus providing two flexible metal tubes. Each of the flexible metal tubes includes two segments.

Then, the first segment of each flexible metal tube is printed with the first group of lines 122, the second group of lines 123 and the third group of lines 124.

Then, the first segment of each flexible metal tube is cut along the first group of lines 122, the second group of lines 123 or the third group of lines 124, thus forming three plain blades.

Finally, the plain blades are bent to form the helical blades 121.

To make the air-guiding device shown in FIGS. 6 through 9, the method includes two additional steps. Each flexible metal tube is cut into the segments between the step of printing the first segment of each flexible metal tube and the step of cutting the first segment of each flexible metal tube. Finally, the helical blades 121 are connected to the positioning section 13 after the step of bending the plain blades into the helical blades 121.

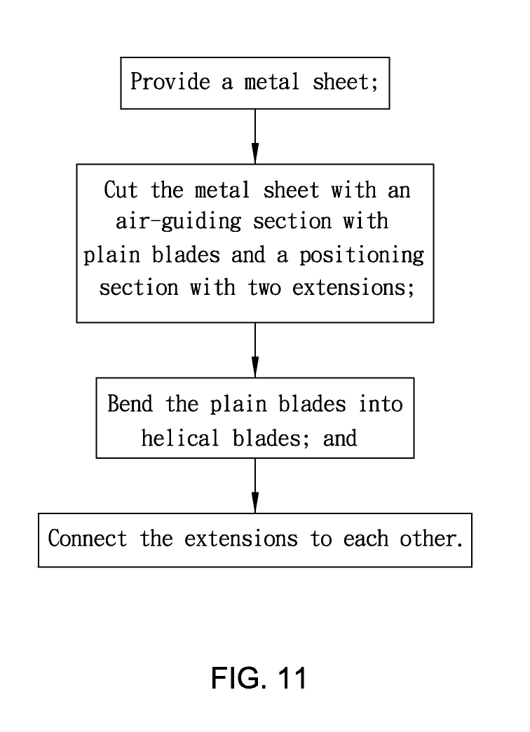

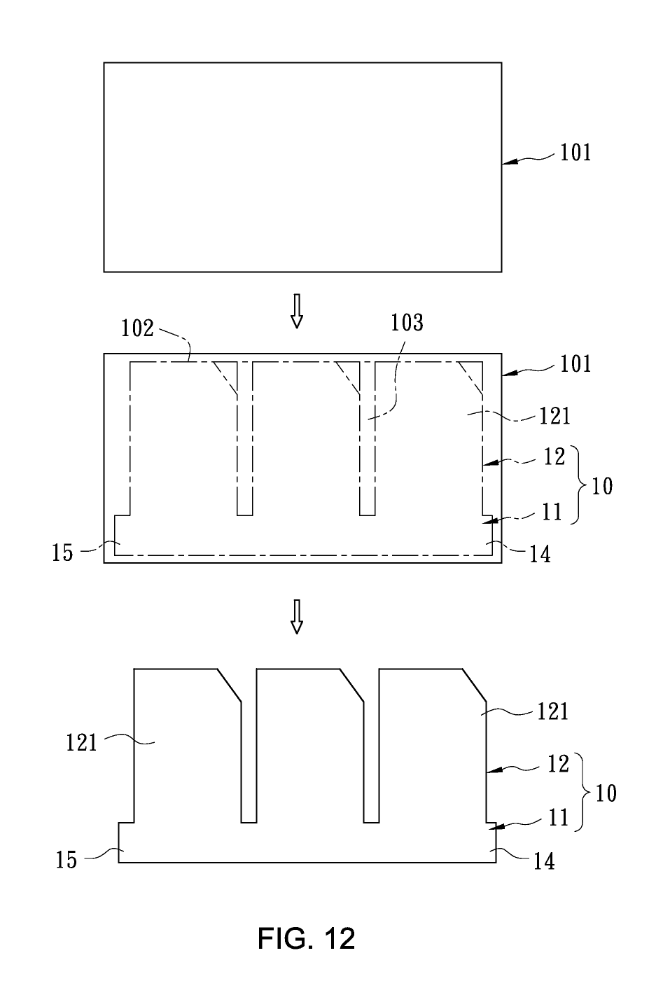

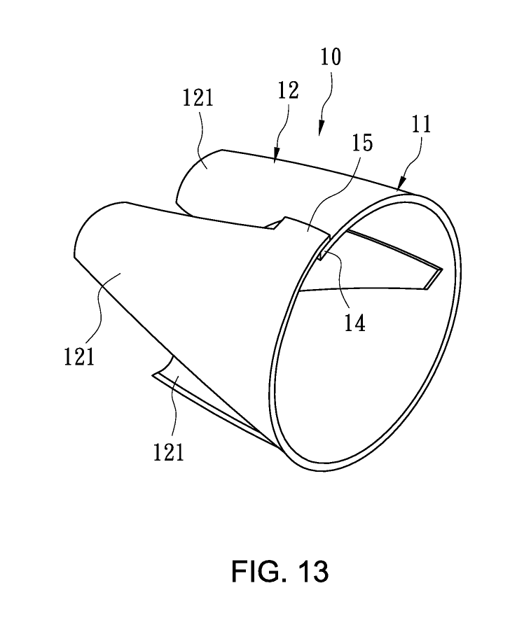

Referring to FIGS. 11 and 12, there is shown a method for making an air-guiding device according to a third embodiment of the present invention as shown in FIG. 13.

At first, there is provided a flexible metal sheet 101.

Then, the flexible metal sheet 101 is printed with a pattern 102.

Then, the flexible metal sheet 101 is cut along the pattern 102. Thus, the flexible metal sheet 101 includes two slits 103 between three plain blades on the air-guiding section 12 and two extensions 14 and 15 on the positioning section 11.

Then, the plain blades are bent into the helical blades 121.

Finally, the extensions 14 and 15 are connected to each other by adhesion for example.

The method for making the air-guiding device according to the third embodiment is better than the methods for making the air-guiding device according to the first or second embodiment is that the air-guiding device can be placed in the intake manifold 110 and the size can be adjusted according to that of the intake manifold 110 even before the extensions 14 and 15 are connected to each other.

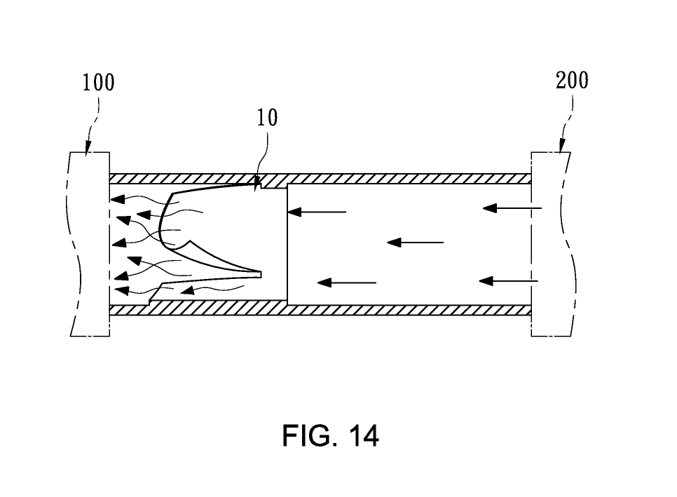

Referring to FIG. 14, there is shown an air-guiding device according to a fourth embodiment of the present invention. The fourth embodiment is like the first embodiment except that the air-guiding device 10 and the intake manifold 110 are made in one piece.

The air-guiding device 10 can be used in the intake manifold 110, which is arranged between the internal combustor 100 and the air-filtering device 200. The helical blades 121 produce turbulences in air that flows into the internal combustor 100 from the air-filtering device 200 via the intake manifold 110. The air mixes with fuel in the internal combustor 100 fast.

Advantageously, the air-guiding device 10 can be made at a lower cost than the prior art. This is because only a flexible metal sheet or can is needed to make the air-guiding device 10.

Moreover, the air-guiding device 10 can be made more easily than the prior art. This is because only a pair of scissors is needed to cut the flexible metal sheet or can into the air-guiding device 10.

Moreover, the air-guiding device 10 is environmentally friendly since the metal can or sheet may be recycled.

Moreover, the efficiency of the air-guiding device 10 is higher than the prior art because the helical blades 121 can easily be bent as desired since it is made of flexible material, and there is no axle to interfere with the travel of the air in the intake manifold 110.

Moreover, the air-guiding device 10 can be used in the intake manifold 110 more easily than the prior art since it is made of the flexible material and can simply be fit in the intake manifold 110.

Moreover, the size of the air-guiding device 10 can easily be adjusted based on that of the intake manifold 110 while such adjustment is almost impossible in the prior art.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An air-guiding device for use in an intake manifold arranged between an internal combustor and an air-filtering device, wherein the air-guiding device is made of a flexible metal sheet and includes:
an annular positioning section fit in the intake manifold; and
an air-guiding section including helical blades that converge as they extend from an end of the positioning section.

2. The air-guiding device according to claim 1, wherein the positioning section and the air-guiding section are made in one piece.

3. The air-guiding device according to claim 1, wherein the positioning section and the air-guiding section are made independent of each other, wherein each of the helical blades includes a tab connected to the positioning section.

4. The air-guiding device according to claim 3, wherein the positioning section includes slots defined therein and an insert inserted in a selected one of the slots.

5. The air-guiding device according to claim 4, wherein each of the helical blades is printed with several lines along which it can be cut into a smaller similar configuration.

6. A method for making an air-guiding device including the steps of:
providing a flexible metal tube;
forming plain blades by cutting the flexible metal tube; and
forming helical blades by bending the plain blades.

7. The method according to claim 6, including the steps of providing a metal can, cutting the metal can into halves, and cutting a cover from each half of the metal can to provide two flexible metal tubes before the step of providing the flexible metal tube.

8. The method according to claim 6, including the step of printing the flexible metal tube with two groups of lines before the step of providing the plain blades.

9. The method according to claim 8, the step of providing the plain blades includes the step of cutting the flexible metal tube along one of the groups of lines.

10. The method according to claim 6, including the step of printing the flexible metal tube with three groups of lines before the step of providing the plain blades.

11. The method according to claim 10, the step of providing the plain blades includes the step of cutting the flexible metal tube along one of the groups of lines.

12. The method according to claim 6, wherein the step of forming the plain blades includes the steps of cutting the flexible metal tube into two segments and cutting one of the segments into the plain blades.

13. A method for making an air-guiding device including the steps of:
providing a flexible metal sheet;
providing a positioning section and an air-guiding section by cutting the flexible metal sheet;
forming plain blades by cutting slits in the air-guiding section;
rolling the positioning section; and
bending the plain blades into helical blades.

14. The method according to claim 13, wherein the step of providing the positioning section and the air-guiding section includes the steps of:
printing the flexible metal sheet with a pattern; and
cutting the flexible metal sheet along the pattern.

15. The air-guiding device according to claim 13, wherein the step of providing the positioning section and the air-guiding section includes the step of providing the positioning section with two extensions, wherein the step of rolling the positioning section includes the step of connecting the extensions connected to each other.
